(19) United States
(12) Patent Application Publication
(10) Pub. No.: US 2008/0000588 A1
(43) Pub. Date: Jan. 3, 2008

(54) Adhesive tape joining apparatus

(75) Inventors: Yoshio Nakagawa, Osaka (JP); Osamu Degawa, Osaka (JP); Hiroichi Ukei, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Nitto Denko Corporation, Ibaraki-shi (JP)

(21) Appl. No.: 11/819,028

(22) Filed: Jun. 25, 2007

(30) Foreign Application Priority Data
Jun. 28, 2006 (JP) 2006-178162

(51) Int. Cl. B32B 37/00

(52) U.S. Cl. 156/391

(57) ABSTRACT

A main body of an apparatus is moved along a longitudinal direction of a workpiece by guiding it so as to be engaged with an edge of the workpiece. In this case, a tape portion protruded from the workpiece is folded back before a top of the edge by a first pressing portion provided to the main body of the apparatus while pressing it. Then, the folded tape portion is pressed after a rear face of the edge by a second pressing portion provided to the main body of the apparatus.

### BACKGROUND OF THE INVENTION

(1) Field of the Invention

The present invention relates to an adhesive tape joining apparatus used when an adhesive tape is joined to a curved workpiece such as a door sash of an automobile.

(2) Description of the Related Art

In recent years, in a manufacturing process of an automobile, in place of black coating processing on a door sash, a technology to join a black adhesive tape has been developed. For example, an adhesive tape joining apparatus (an adhesive tape joining jig) has been suggested. Herein, an adhesive tape from which a separator is separated is elastically pressed against a joining face with a joining roller to be joined thereto while guiding and moving this adhesive tape joining apparatus on hand along a workpiece (refer to JP-A 2001-115).

This apparatus is provided with four bottom guide rollers to be engaged on back and forth and right and left of a bottom face that is a joining face of the workpiece and four side guide rollers to be engaged on back and forth two places of the right and left side faces of the workpiece at its base. In addition, a single pressing roller to be elastically pressed against the upper face of the workpiece is mounted on a pressing lever that is pivotally connected to the base. In other words, a bottom guide roller group and the pressing roller sandwich the workpiece vertically so as to keep the posture of the apparatus with respect to the workpiece. Further, by engaging the side guide rollers from right and left of the workpiece, positioning in a right and left direction of this apparatus with respect to the workpiece is made.

Thus, moving the apparatus of which position and posture are determined along a workpiece due to the guidance of engagement by the roller group, the adhesive tape is elastically pressed against the bottom face of the workpiece by an elastic roller arranged at the rear end of the base to be joined thereto. In addition, the adhesive tape to be supplied is curved and guided ahead of the elastic roller, and the separator is peeled-off to be fed forward in a joining moving direction through a gap formed between the base and a sliding plate.

However, a phenomenon that the separator is difficult to be separated from the adhesive tape under an atmosphere within a predetermined temperature range depending on a base material, an adhesive compound, and a material of the separator to be used for the adhesive tape is caused. In the case of joining the adhesive tape on the workpiece by using the suggested adhesive tape joining apparatus under the atmosphere that this phenomenon is caused, the adhesive tape which cannot be peeled-off by the separator is tangled by the joining roller. In other words, this involves a problem that it is not possible to join the adhesive tape on the joining face with high accuracy.

### SUMMARY OF THE INVENTION

The present invention has been made taking the foregoing problems into consideration and an object of which is to provide an adhesive tape joining apparatus that can join an adhesive tape with high accuracy while separating a separator from an adhesive tape in a stable state.

In order to attain the aforementioned object, the present invention may include the following configuration:

An adhesive tape joining apparatus which supplies an adhesive tape to a joining roller while moving forward along a workpiece and joins this adhesive tape on a tape joining face of the workpiece by pressing this adhesive tape against the tape joining face, the apparatus comprising the followings:

a guide member which determines the position of the main body and keeps the posture of the main body with respect to the workpiece being engaged with the outer face of the workpiece which is different from this joining face on the main body which is moved and operated along the joining face;

a joining roller, which can be elastically transformed, for joining the adhesive tape to the joining face by pressing the adhesive tape against the joining face with the adhesive tape peeled-off from the separator being wounded and guided;

a separator guide which is arranged in such a manner that a separator guide face for discharging and guiding the peeled-off separator in a direction different from an adhesive tape joining moving direction is formed, a front end of the separator guide face is adjacent to a top at the side of adhesive tape feeding of the joining roller, and its front end is positioned within ½ of the radius of the joining roller; and

a tape guide for preventing disengagement of the adhesive tape that is fed into the joining roller.

According to the adhesive tape joining apparatus of the present invention, by moving this apparatus of which position and posture are secured by the guide member along the workpiece, the adhesive tape is guided and supplied to the joining roller via the tape supply roller, and the adhesive tape pressed by the joining roller is continuously joined to the joining face. In addition, being wound around the joining roller, the adhesive tape turns around to be guided to the joining roller. On the other hand, the separator does not turn around and is peeled-off at the region where the tape is wound to move toward the separator guide. Then, the separator is guided to the separator guide face to be released in a direction that is not obstructive to joining of the tape.

In this case, a front end of the separator guide face is adjacent to a top at the adhesive tape feeding side of the joining roller and the separator guide is arranged so that its front end is positioned within ½ of the radius of the joining roller. Therefore, a gap formed by the joining roller and the separator guide face becomes narrow. Accordingly, when the separator is nearly fed into the joining roller together with the adhesive tape while being flexed without being peeled-off, feeding is regulated by the front end of the separator guide. Further, since the front end of the separator guide is adjacent to the top of the joining roller, it is possible to positively separate the separator from the adhesive tape. In other words, the adhesive tape can be joined to the workpiece with high accuracy.

Further, in this apparatus, it is preferable that the separator guide is configured so that the guide face is curved along the discharge direction of the separator, and for example, the separator guide is configured by a taper-shaped block or a plate material having a curved guide face. In addition, it is more preferable that an opening angle made by a virtual line that is drawn being in parallel with the adhesive tape joining face of the workpiece passing through a peeled-off point on which the separator is peeled-off from the adhesive tape and a virtual line that is drawn from the peeled-off point toward a front end of the separator guide face becomes an acute angle.

According to this configuration, the front end of the separator guide can be made into an acute angle. In other words, it is possible to narrow opening angles (peeled-off angles) of the both members when the separator is peeled-off from the adhesive tape, so that it is possible to separate the separator from the adhesive tape with a small separation force. As a result, extension and deformation or the like of the adhesive tape generated by the operation of the separation force are prevented and this makes it possible to join the adhesive tape on the tape joining face with high accuracy.

The separator guide of the apparatus is preferably configured so as to be capable of being switched between an operational posture for guiding a separator opposed to the joining roller and a release posture which is largely separated from the joining roller.

According to this configuration, at the beginning of the joining operation, the adhesive tape is guided to the joining roller via the tape guide. However, in this case, by switching the separator guide close to and opposed to the joining roller into a release posture, the winding setting of the adhesive tape and the separation operation of the separator can be easily carried out in a wide space.

Further, it is preferable that the separator guide is rotatably supported around a support point directed in a back and forth direction along a tape joining moving direction.

According to this configuration, the separator guide which is switched and swung into the release posture is largely separated into lateral outside of the adhesive tape joining apparatus and the front side and the lateral outside of the joining roller are largely released. As a result, it is possible to easily carry out the winding setting of the adhesive tape and the separation operation of the separator in a wide space.

In addition, it is preferable that this apparatus is provided with a posture keeping means which stably keeps the separator guide located in the operational posture for guiding the separator and gives operational resistance when the operational posture for guiding the separator is switched into the release posture.

According to this configuration, the separator guide positioned at the operational posture for guiding the separator does not move to the release side without discretion and during the joining operation, a desired separator guiding operation can be effected in an appropriate manner.

It is preferable that this apparatus is provided with a posture keeping means which stably keeps the separator guide in the release posture and gives operational resistance when the separator guide is switched into the operational posture for guiding the separator.

According to this configuration, the separator guide in the release posture does not come close and move to the tape supply roller without discretion and does not obstruct the setting operation of the adhesive tape.

It is further preferable that the apparatus is provided with both of the above-described posture keeping means.

Each of the above-described posture keeping means is configured, for example, by a detent mechanism to elastically engage a ball which can be moved backward elastically in an engagement hole.

According to this configuration, the separator guide in the operational posture for guiding the separator or the release posture is not moved by small external force to be stably kept in the posture. In other words, if an operational force more than the predetermined force is provided to the separator guide, due to elastic backward moving of a ball, a posture keeping function is released, so that the separator guide can be moved into a desired direction. In this case, since the ball which is moved backward moves on a surface of other component by point contact, the separator guide can be lightly moved.

It is preferable that the apparatus is provided with an abutting means for positioning the separator guide in the operational posture for guiding the separator.

According to this configuration, only by returning and moving the separator guide in the release posture without discretion till it cannot be moved, it is possible to accurately position the separator guide in a predetermined operational posture for guiding the separator. As a result, the separator guide returning operation after setting the adhesive tape can be carried out immediately, so that excellent handling properties can be obtained.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view of an adhesive tape joining apparatus which is mounted on a workpiece;

FIG. 2 is a partially notched front view of the adhesive tape joining apparatus which is mounted on the workpiece;

FIG. 3 is a cross sectional plan view of the adhesive tape joining apparatus which is mounted on the workpiece;

FIG. 4 is a side view of the adhesive tape joining apparatus;

FIG. 5 is a partially notched side view showing the adhesive tape joining apparatus seen from other direction;

FIG. 6 is a view showing separation operation of a separator;

FIG. 7 is a partially notched side view showing substantial parts showing other embodiment of a posture keeping means; and

FIG. 8 is a partially notched side view showing substantial parts showing still other embodiment of the posture keeping means.

### DESCRIPTION OF THE PREFERRED EMBODIMENTS

An embodiment of the present invention will be described below with reference to the drawings.

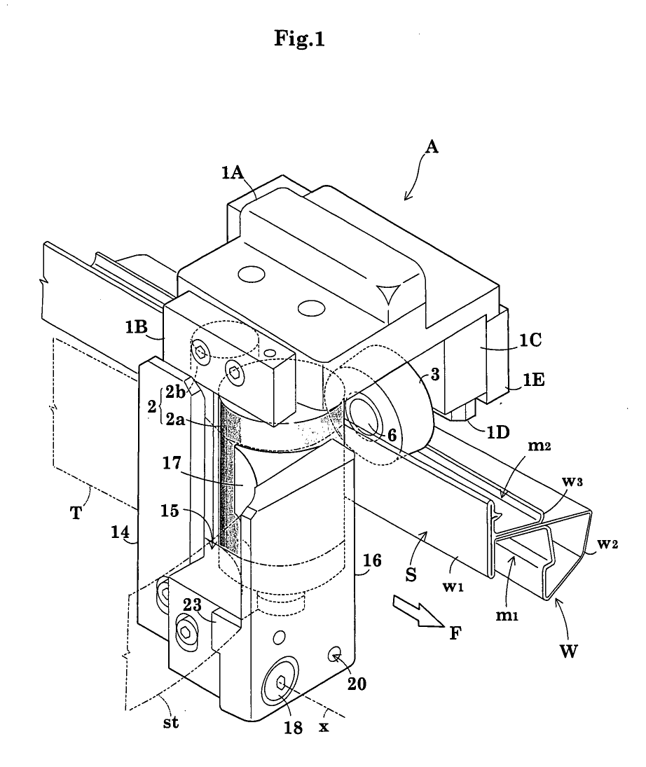

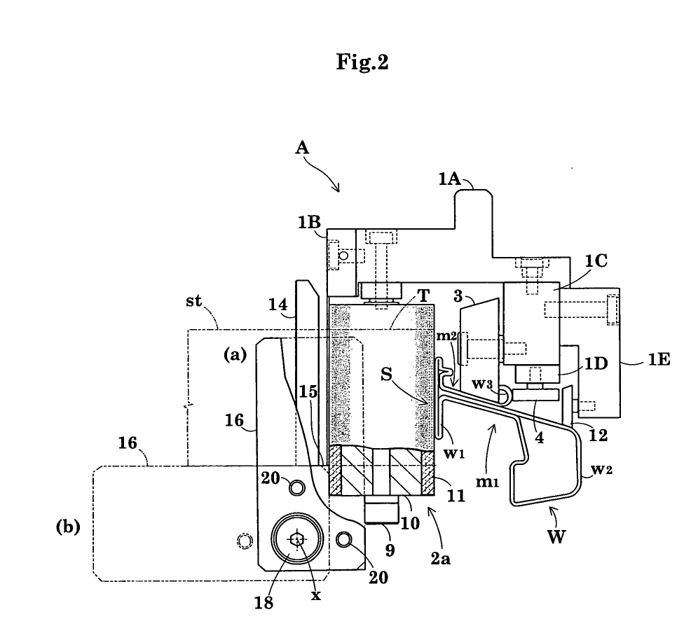

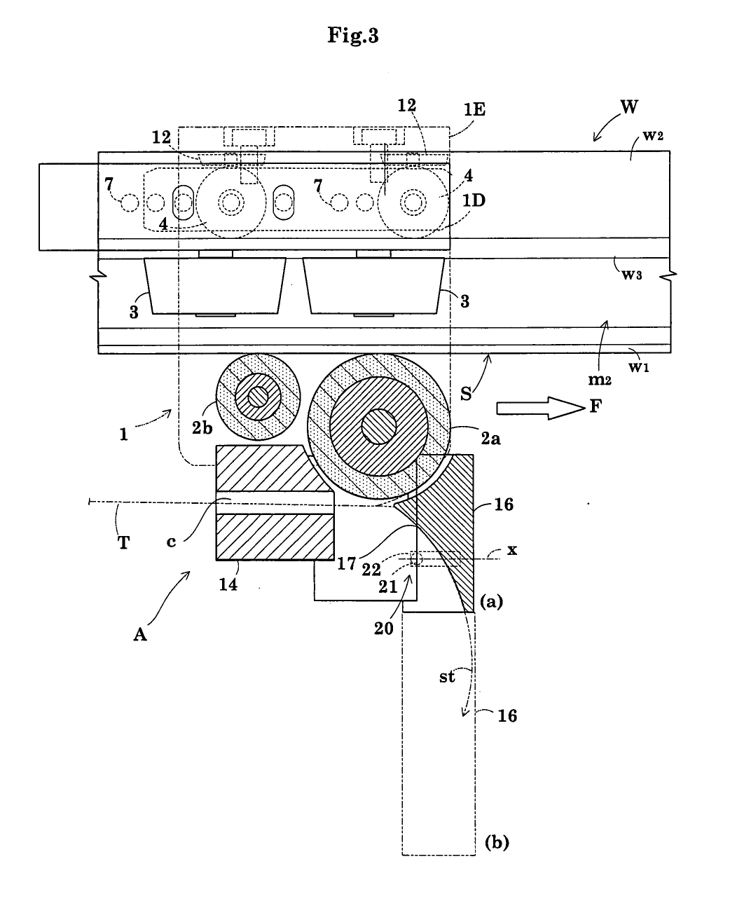

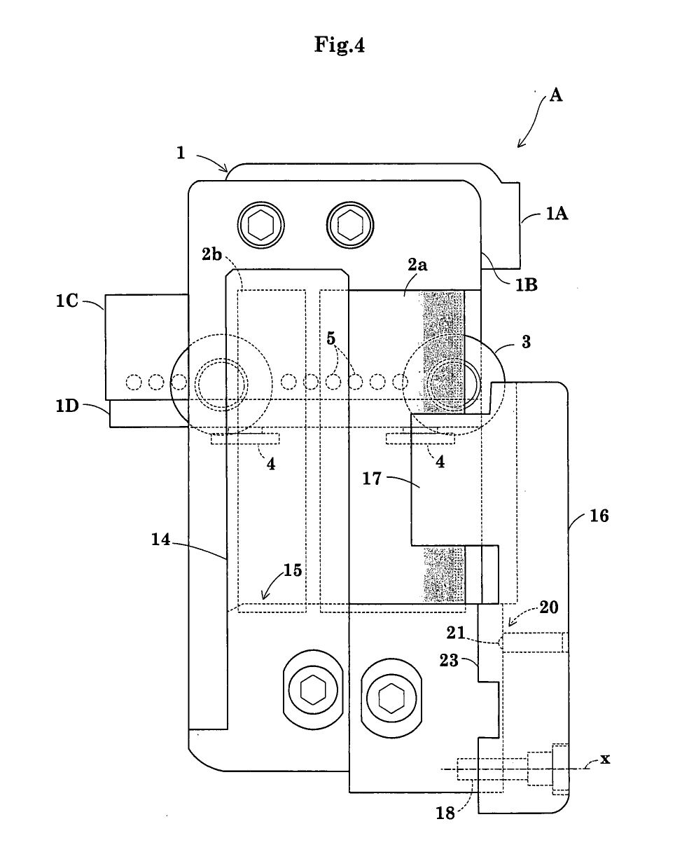

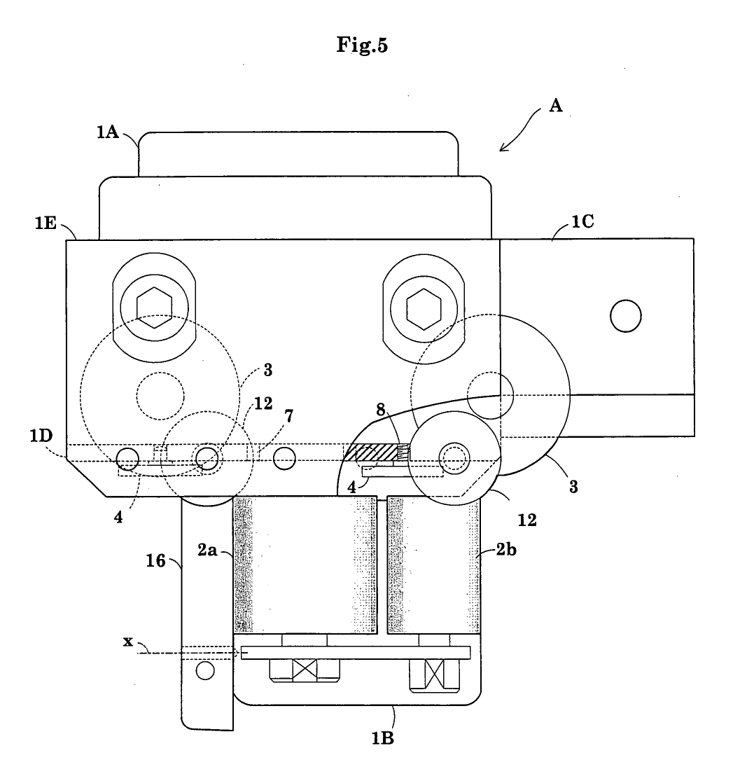

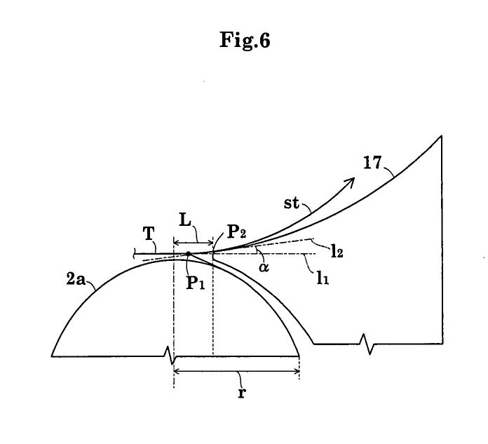

FIG. 1 is a perspective view of an adhesive tape joining apparatus A according to the present invention which is mounted on a workpiece W, FIG. 2 is its front view, FIG. 3 is its cross sectional plan view, FIG. 4 and FIG. 5 are side views of the adhesive tape joining apparatus, and FIG. 6 is an exploded perspective view of the adhesive tape joining apparatus A, respectively.

Further, the workpiece W according to the present embodiment is a door sash of an automobile, and a black adhesive tape is joined to the inner circumferential face of the inside of the automobile in place of black coating.

The workpiece W is configured by press polymerization of a single steel plate. This workpiece W has an outer frame w1 shaped in a longitudinal wall at the lateral outside that is the outer face of the door of the work W, and the workpiece W is formed with a cross section that a hollow lateral frame w2 thrusting from this outer frame w1 toward the inside of the door (the right side in FIG. 2) is connected. Then, between a hollow region of the lateral frame w2 and the outer frame w1, a window glass mounting groove m1 is formed. In addition, at right and left middle region of the upper face of the lateral frame w2, a rib w3 is protruded along the longitudinal direction of the workpiece. Between this rib w3 and the outer frame w1, a weather strip mounting groove m2 is formed. Then, the outer face at the outer frame w1 becomes a tape joining face S. On this fasting face S, an adhesive tape T is joined by a manual fashion by using an adhesive tape joining apparatus A according to the present invention. As the adhesive tape T, an adhesive tape with a separator that is wider than the joining face S is used.

As shown in FIG. 1 and FIG. 2, this apparatus A may join the adhesive tape T being guided and engaged to the workpiece W while moving along the workpiece longitudinal direction by the manual labor. In the following description, as a matter of convenience, a direction F of joining and moving the adhesive tape joining apparatus A is called as a front direction, and a door inside and outside directions that are perpendicular to the tape joining direction are called as a lateral direction or a right and left direction.

The main body 1 of this apparatus A is formed by a hard resin material and the main body 1 is configured by a first bracket 1A shaped in an angular block, a second bracket 1B that is coupled by a bolt to perpendicular protrude downward to one end of this first bracket 1A, a third bracket 1C shaped in an angular bar which is long in back and forth that is coupled to the other end of the first bracket 1A by a bolt so that its position can be adjusted back and forth to protrude perpendicularly downward, a support plate 1D which is coupled to the lower face of the third bracket 1C by a bolt so that its position can be adjusted to right and left, and a fourth bracket 1E shaped in L that is coupled to the outside face of the third bracket 1C by a bolt.

Near one end on the lower face of the first bracket 1A, a pair of back and forth joining rollers 2 (2a, 2b) that can freely idle around a longitudinal axial core is mounted downward like a cantilever. In addition, on the inside face at the front end of the third bracket 1C, as a guide member, a pair of back and forth guide rollers 3 is mounted around a lateral core axis so as to freely idle. Further, on the support plate 1D connected along the lower face of the third bracket 1C, as shown in FIG. 2 and FIG. 3, as another guide member, a pair of back and forth guide rollers 4 is mounted so as to freely idle.

The guide roller 3 is formed by a hard resin material excellent in smoothness. In addition, this guide roller 3 is inserted and engaged in a weather strip mounting groove m2 at the workpiece W to be engaged to the upper face of a lateral frame w2 so as to be in a taper shape. In addition, the guide roller 4 is also formed by a hard resin material excellent in smoothness and they are engaged with the convex curved outside face of the rib w3. In this way, since the guide rollers 3 and 4 are engaged at plural parts of the lateral frame w2 from the upper direction and the lateral side direction, the posture and the position of the adhesive tape joining apparatus A with respect to the workpiece W are stably kept.

Further, by adjusting the position of the third bracket 1C back and forth, it is possible to switch and adjust the back and forth positions of the guide rollers 3 and 4. In addition, as shown in FIG. 4, selecting a plurality of back and forth screw holes 5 provided on the inside face of the third bracket 1C and screwing and mounting a support shaft 6 of the guide roller 3, it is also possible to adjust the back and forth position of the guide roller 3. In addition, by adjusting the position of the support plate 1E right and left, the right and left position of the guide roller 4 can be adjusted. In addition, as shown in FIG. 3 and FIG. 5, by selecting a plurality of back and forth screw holes 7 mounted on the support plate 1E and screwing and mounting a support shaft 8 of the guide roller 4, it is possible to adjust the back and forth position of the guide roller 4.

On the inside face of the fourth bracket 1E, as another guide member, a pair of back and forth guide rollers 12 is mounted so as to freely idle.

The guide roller 12 is formed by a hard resin material excellent in smoothness. In addition, the guide roller 12 is formed in a taper shape so as to roll on a flat face of the workpiece which is inclined downward from the convexly curved outside face of the rib w3 formed on the workpiece W to the lateral frame w2. In other words, even if a force is effected to the outside of the main body of the apparatus, the main body of the apparatus is supported by the guide roller 12, so that falling of the main body is prevented. In other words, in a step of jointing the adhesive tape, staggering of the main body of the apparatus is prevented, so that the posture and the position of the adhesive tape joining apparatus A with respect to the workpiece W are stably kept.

As shown in FIG. 3, the joining roller 2 in which the forward joining roller 2a has a larger diameter than that of the backward joining roller 2b is mounted. As shown in FIG. 2, the both joining rollers 2a and 2b are configured by covering a tubular axis 10 externally fitted to a fixed core axis 9 so as to freely idle with a sponge-like elastic layer 11. In other words, with the guide rollers 3 and 4 engaged to a predetermined position and a posture with respect to the workpiece W, the joining roller 2 is pressed against the joining face S while being elastically transformed in moderation.

On the outside face of the second bracket 1B, a platy tape guide 14 formed by a hard resin material is attached. As shown in FIG. 2, a tape insertion gap c released back and forth and upward is formed between this tape guide 14 and the outside face of the second bracket 1B. In addition, as shown in FIG. 3, the bottom end of this tape insertion gap c is formed on a tape positioning part 15, and by accepting and supporting one side edge of the adhesive tape T inserted in this tape insertion gap c by means of the tape positioning part 15, positioning of the adhesive tape T is carried out in a width direction. Further, the tape guide 15 is attached in an upper and lower direction, namely, in a tape width direction so that its position can be adjusted.

In addition, on the front end face of the tape guide 14, a separator guide 16 formed of a hard resin material is attached. This separator guide 16, as shown in FIG. 1 and FIG. 3, is arranged being opposed to the joining roller 2a at a small interval at a front position of the joining roller 2a and is arranged slightly lower than the tape supply roller 12. Then, a separator guide face 17 formed in a substantially taper shape from a forward direction to a backward direction is formed.

The separator guide face 17 is curved (concavely curved) along a discharge direction of the separator st and the opposed face at the side of the adhesive tape is also concavely curved being opposed to the joining roller 2a. In addition, as shown in FIG. 6, the front end of the separator guide face 17 is adjacent to the top of the joining roller 2a at the front side and the separator guide 16 is arranged so that its front end position P2 is positioned within ½ of a radius r of the joining roller 2a.

Further, the separator guide face 17 is arranged on the position where an opening angle α made by a virtual line 11 that is drawn being in parallel with the tape joining face S of the workpiece W passing through a peeled-off point P1 (a position) on which the separator st is peeled-off from the adhesive tape T and a virtual line 12 that is drawn from the peeled-off point P1 toward the front end position P2 of the separator guide face 17 becomes an acute angle. In other words, the separator guide face 17 is arranged so that a relation of a radius r/2>a distance L is established.

Further, according to the present embodiment, the joining roller 2a having a diameter of 26 mm is used. The front end position P2 of the separator guide face 17 in this case is determined not more than 6.5 mm which is equivalent to not more than ½ of the radius r of the joining roller 2a. Further, it is preferable that the front end position P2 of the separator guide face 17 is not more than 6 mm depending on a base material, an adhesive compound, and a material of the separator st or the like to form the adhesive tape T. More preferably, the front end position P2 is not more than 4 mm. At the same time, according to this embodiment, the opening angle α is 24°. In addition, it is preferable that this opening angle α is not more than 40° depending on the front end position P2 of the separator guide face 17 and a base material, an adhesive compound, and a material of the separator st or the like to form the adhesive tape T. More preferably, this opening angle α is 24°.

In addition, as shown in FIGS. 1 to 3, the separator guide 16 is pivotally connected around a support point x swingably via a support point axis 18 on the front face of the tape guide 14. As a result, the separator guide 16 can be switched between (a) the operational posture for guiding a separator opposed close to the tape supply roller 12 while rising and swinging and (b) a release posture which is turned down and swung in lateral outside and largely separated from the tape supply roller 12.

At the opposed region between the separator guide 16 and the tape guide 14, as a means for stably keeping the separator guide 16 in (a) the operational posture for guiding the separator and (b) the release posture, a detent mechanism 20 is mounted. This detent mechanism 20, as shown in FIG. 3, is configured by two sets of balls 21 fitted to the separator guide 16 and a single engage concave part 22 formed on the front end face of the tape guide 14 at a phase of 90 degrees around the support point x. In other words, when the separator guide 16 is in (a) the operational posture for guiding the separator, one ball 21 is engaged with the engage concave part 22. When the separator guide 16 is in (b) the release posture, the other ball 21 is engaged with the engage concave part 22. Accordingly, each posture is stably kept by this mechanism 20.

When a swinging operational force more than a keeping force of the detent mechanism 20 is given to the separator guide 16 in (a) the operational posture for guiding the separator or (b) the release posture, the ball 21 being engaged is elastically moved back to be mounted on the front end face of the tape guide 14. After that, with light operational force, the separator guide 16 can be swung. Then, if the separator guide 16 is returned to a predetermined posture position, the ball 21 which is biased by a spring is engaged to the engage concave part 22 while getting down so as to be kept in this posture.

Further, rising and swinging the separator guide 16 till (a) the operational posture for guiding the separator, as shown in FIG. 4, a project piece 23 continued at the side edge of the separator guide 16 abuts against the outside face of the tape guide, so that the positioning of the separator guide 16 in (a) the operational posture for guiding the separator is made.

The adhesive tape joining apparatus A according to the present invention is configured as described above. Next, by using the apparatus A according to the above-described embodiment, a step of joining the adhesive tape T on the workpiece W will be described below.

First, an operator mounts the apparatus A on the joining start position of the workpiece W by using the guide rollers 3 and 4.

Next, inserting the adhesive tape T with a separator through the tape insertion gap c in a longitudinal posture where a separator st of the tape T is directed to lateral outside, and then, peeling off the separator st from the front end of the adhesive tape T, the adhesive face is exposed. Then, winding and guiding this adhesive tape T by the joining roller 2a, the adhesive tape T is joined on a predetermined position of the joining face S of the workpiece W. In this case, by swinging the separator guide 16 in lateral outside and keeping it in (b) the release posture, the front side of the tape supply roller 12 is largely opened so that the operation is easily carried out.

Next, by rising and swinging the separator guide 16 and returning the separator guide 16 to (a) the operational posture for guiding the separator close to and opposing the joining roller 2a, the separator st peeled off from the adhesive tape T is guided by the separator guide face 17 of the separator guide 16 to be introduced to the lateral outside. This completes setting of the adhesive tape.

After that, winding the adhesive tape T by the joining roller 4 and elastically pressing it against the joining face S, the apparatus A is moved to the front direction F along the workpiece W. Due to this movement, it is possible to continuously join the adhesive tape T on the joining face S while positioning the adhesive tape T in a width direction.

In this case, if the apparatus A is moved to the front direction F, the adhesive tape T is relatively moved to the front direction F. Due to this operation, as shown in FIG. 2, the separator st is positively peeled-off from the adhesive tape T at the peeled-off point P1 on a front side of its front end by the acute opening angle α formed by the front end P2 of the separator guide face 17 of the separator guide 16.

The peeled-off separator st is fed in a direction separated from the joining roller 2 being turned around and guided along the curved separator guide face 17. As a result, it is prevented that the separated separator st is involved in the joining roller 2a without peeled off from the adhesive tape T to come close to the joining face S or is interrupting the forward movement of the apparatus A in advance.

In addition, the tape part protruded from the joining face S is tangled and joined at the upper and lower end portions of the outer frame w1 in a later step. As a result, the appearance of the adhesive tape T joined on the workpiece W is the same as that of the coated tape.

In addition, the right and left direction and the back and forth direction of the guide rollers 3 and 4 can be adjusted with respect to the workpiece W in a different specification according to need. Further, in accordance with change of a width of the adhesive tape T, it is possible to adjust the positions of the tape guide 14 and the separator guide 16 upward and downward.

The present invention is not limited to the above-described embodiment and it can also be practiced in the following forms.

### (1) According to the above-described embodiment, the region of the separator guide face 17 of the separator guide 16 is formed by a taper-shaped block, however, a concavely curved platy one may be used in a discharge direction of the separator st.

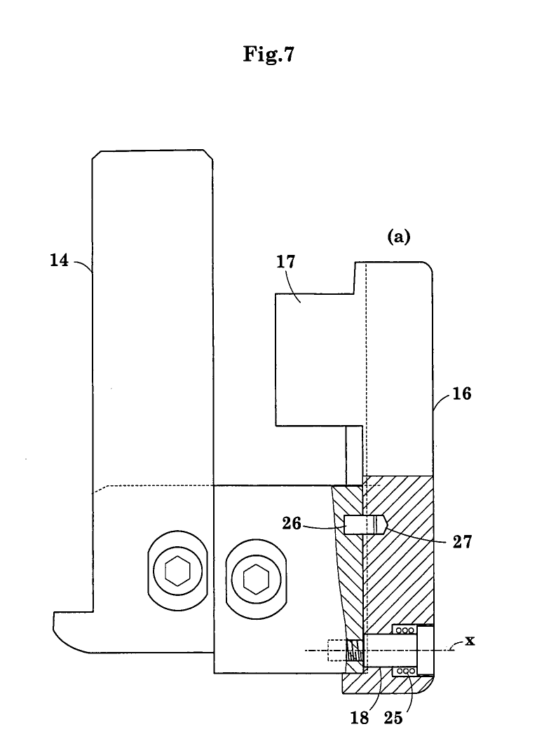

(2) In the above-described embodiment, it is also possible to mount a single ball 21 on the tape guide 14 and provide a pair of engagement holes 22 in which this ball 21 is engaged on the separator guide 16 to configure the detent mechanism 20 for keeping the posture.
(3) As shown in FIG. 7, the separator guide 16 can be freely slid with respect to the support point axis 18. In addition, by pressing and biasing the separator guide 16 to the side of the tape guide 14 by a compression coil spring 25 which is externally fitted to the support point axis 18, a single engagement projection 26 and a pair of engage concave parts 27 may be formed, respectively, on the opposed slid face of the tape guide 14 and the separator guide 16, and the engagement projection 26 may be selected and engaged to any one of the engage concave parts 27. In this configuration, the detent structure in which the separator guide 16 is stably kept in (a) the operational posture for guiding the separator or (b) the release posture, respectively, may also be used. In this case, the separator guide 16 is operated as follows; First, slightly pull the separator guide 16 against the compression coil spring 25 to the front side to move it and separate the engagement projection 26 from the engage concave part 27, then the separator guide 16 is swingably operated around the support point x. In other words, two action operation is carried out.

Further, a head part of the engagement projection 26 may be formed in a hemisphere. In this case, only by swingably operating the separator guide 16, the separator guide 16 is displaced slidably to the front side against the compression coil spring 25 due to the mounting operation of the engagement projection 26 and the engage concave part 27. As a result, similarly to the above-described embodiment, the posture of the separator guide 16 can be switched by one action operation.

(4) As the format of moving the separator guide 16 into the separator guide posture and the release posture, as described above, the following formats can be considered in addition to the format of swinging the separator guide 16 around the support point x directed back and forward.

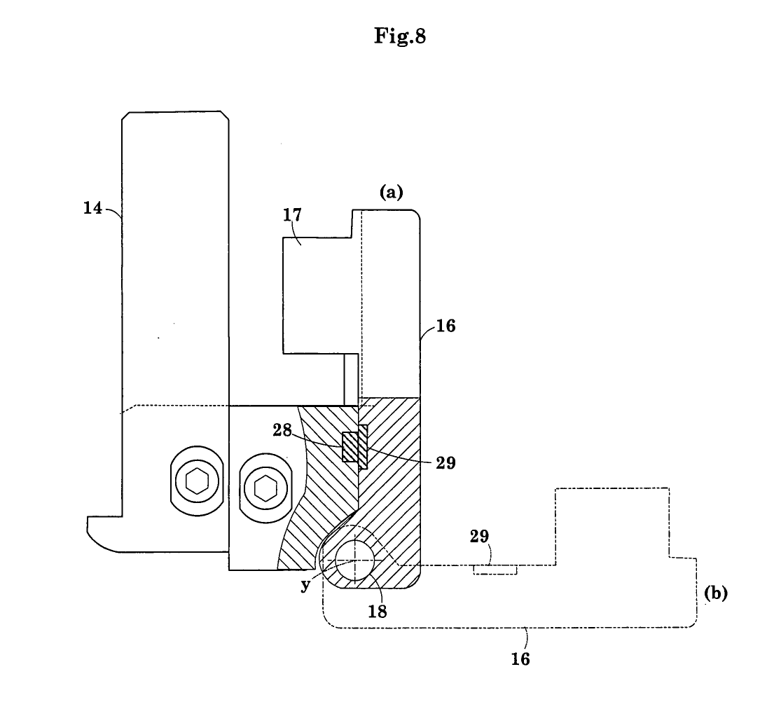

For example, as shown in FIG. 8, the separator guide 16 is pivotally coupled to the tape guide 14 via the support point axis 18 around the support point y directed right and left so as to be capable of swinging upward and downward. Then, in (a) the operational posture for guiding the separator of raising and swinging the separator guide 16 and abutting the separator guide 16 against the front face of the tape guide 14, an iron element 29 embedded on the rear face of the separator guide 16 is adsorbed by a magnet element 28 embedded on the front face of the tape guide 14. According to this adsorption operation, the posture can be kept. In addition, lowering and swinging the separator guide 16 to overcome the adsorption force of the magnet element 28, the separator guide 16 is kept in the release posture with the base of the separator guide 16 abutting against a part of the tape guide 14.

(5) In the configuration that the separator guide 16 is supported swingably between (a) the operational posture for guiding the separator and (b) the release posture, mounting an elastic friction material such as a spring clip plate and a clip plate with rubber at its swinging support point, appropriate resistance may be given to the swing operation of the separator guide 16. According to this configuration, it is possible to keep the separator guide 16 in the operational posture for guiding the separator and the release posture with friction, respectively.
(6) Although it is not illustrated, the separator guide 16 may be fitted and supported to the tape guide 14 so as to be capable of sliding and moving in a back and forth direction, or in a right and left direction, or in an upper and lower direction by using a linear guide mechanism such as a guide groove, a guide rail, or a guide axis or the like. According to these configurations, the present invention can also be practiced in the formation that the separator guide 16 is in (a) the operational posture for guiding the separator at a slide limitation that the separator guide 16 abuts against the tape guide 14 and (b) the release posture at a pulling slide limitation in a direction separated from the tape guide 14.

The present invention may be embodied in other specific forms without departing from the spirit or essential attributes thereof and, accordingly, reference should be made to the appended claims, rather than to the foregoing specification, as indicating the scope of the invention.

What is claimed is:

1. An adhesive tape joining apparatus which supplies an adhesive tape to a joining roller while moving forward along a workpiece and joins this adhesive tape on a tape joining face of the workpiece by pressing this adhesive tape against the tape joining face, the apparatus comprising the followings:
a guide member which determines the position of the main body and keeps the posture of the main body with respect to the workpiece being engaged with the outer face of the workpiece which is different from this joining face on the main body which is moved and operated along the joining face;
a joining roller, which can be elastically transformed, for joining the adhesive tape to the joining face by pressing the adhesive tape against the joining face with the adhesive tape peeled-off from the separator being wounded and guided;
a separator guide which is arranged in such a manner that a separator guide face for discharging and guiding the peeled-off separator in a direction different from an adhesive tape joining moving direction is formed, a front end of the separator guide face is adjacent to a top at the side of adhesive tape feeding of the joining roller, and its front end is positioned within ½ of the radius of the joining roller; and
a tape guide for preventing disengagement of the adhesive tape that is fed into the joining roller.

2. The adhesive tape joining apparatus according to claim 1, wherein
the guide face of the separator guide is curved along a discharge direction of the separator.

3. The adhesive tape joining apparatus according to claim 2, wherein
the separator guide is a taper-shaped block having a curved guide face.

4. The adhesive tape joining apparatus according to claim 2, wherein
the separator guide is a plate material having a curved guide face.

5. The adhesive tape joining apparatus according to claim 1, wherein
an opening angle made by a virtual line that is drawn being in parallel with the joining face of the workpiece passing through a peeled-off point on which the separator is peeled-off from the adhesive tape and a virtual line that is drawn from the peeled-off point toward a front end of the separator guide face becomes an acute angle.

6. The adhesive tape joining apparatus according to claim 1, wherein
the separator guide is configured so as to be capable of being switched between an operational posture for guiding a separator opposed to the joining roller and a release posture which is largely separated from the joining roller.

7. The adhesive tape joining apparatus according to claim 6, wherein
the separator guide is rotatably supported around a support point directed in a back and forth direction along a tape joining moving direction.

8. The adhesive tape joining apparatus according to claim 6, wherein
the apparatus further comprising:
a posture keeping means which stably keeps the separator guide located in the operational posture and gives resistance when the posture of the separator guide is switched into the release posture.

9. The adhesive tape joining apparatus according to claim 8, wherein
the apparatus further comprising:
a posture keeping means which stably keeps the separator guide located in the release posture and gives resistance when the posture of the separator guide is switched into the operational posture.

10. The adhesive tape joining apparatus according to claim 8, wherein
the posture keeping means is configured by a detent mechanism to elastically engage a ball which can be moved backward elastically in an engagement hole.

11. The adhesive tape joining apparatus according to claim 1, wherein
the apparatus further comprising:
an abutting means for positioning the separator guide in the operational posture.
